(19) United States
(12) Patent Application Publication
(10) Pub. No.: US 2013/0219965 A1
(43) Pub. Date: Aug. 29, 2013

(54) COUNTER-CURRENT CONTINUOUS ION-EXCHANGE METHOD FOR STRENGTHENING GLASS ARTICLES

(71) Applicant: CORNING INCORPORATED, (US)

(72) Inventors: Douglas Clippinger Allan, Corning, NY (US); Sinue Gomez, Corning, NY (US); William Weston Johnson, Painted Post, NY (US); Hongkyu Kim, Old Bridge, NJ (US); Alper Ozturk, Elmira, NY (US); Gaozhu Peng, Horseheads, NY (US)

(73) Assignee: CORNING INCORPORATED, Corning, NY (US)

(21) Appl. No.: 13/754,188

(22) Filed: Jan. 30, 2013

Related U.S. Application Data
(60) Provisional application No. 61/604,738, filed on Feb. 29, 2012.

(51) Int. Cl. C03C 21/00

(52) U.S. Cl. CPC C03C 21/002
USPC 65/30.14; 65/375

(57) ABSTRACT

This disclosure is directed to a continuous flow ion-exchange system and process (CIOX) in which a fresh molten salt, for example KNO₃, is supplied a salt inlet end of a long channeled containment vessel and the used molten salt is removed from a salt outlet end distal from the inlet end of the channel. Glass article is loaded into at least one cassette, the cassette is placed in the vessel containing the molten salt and is translated from the salt outlet end to the salt inlet end. Cassettes containing glass articles are continuously placed into the vessel at the salt outlet lend and are removed as they reach the salt inlet end.

### PRIORITY

This application claims the benefit of priority under 35 U.S.C. §119 of U.S. Provisional Application Ser. No. 61/604,738 filed on Feb. 29, 2012 the content of which is relied upon and incorporated herein by reference in its entirety.

### FIELD

This disclosure is directed to a continuous flow ion-exchange (“CIOX”) process in which the contents of an ion-exchange bath move counter-current to the movement of the glass article undergoing ion-exchange,

### BACKGROUND

Glass articles such as the flat glass panels used in LCD and plasma televisions, computer screens, cell phones electronic tablets and other devices can be chemically strengthened by an ion-exchange (“IOX”) process in which alkali metal ions in the glass are exchanged for larger alkali metal ions. For example, potassium ions would be ion-exchanged for sodium and/or lithium ions. The ion-exchange process can be a single step ion-exchange process (SIOX) or can be a multiple step process, for example, a dual stage ion-exchange (DIOX) process. In the SIOX process a cassette holding numerous glass sheets is placed in an ion-exchange bath, for example, a potassium nitrate (KNO₃) molten salt bath, at a constant temperature usually between 380-550° C. for a selected time. The cassette has openings in its sides and bottom so that the molten can enter, exit and circulate in the cassette. After the ion-exchange time is reached, the cassette with glass sheets are removed from the bath and subsequently water washed to remove excess salt from the ion-exchange bath that clings to the glass sheets and the cassette. This process continues until the salt bath accumulates enough effluent ions, for example, sodium ions (Na⁺) ion-exchanged out of the glass, to render the salt bath poisoned and ineffective for further use. This poisoning effect of the effluent ions occurs at a nominal effluent ion concentration in the range of 0.5-1 wt % NaNO₃. In the DIOX process the cassette holding glass sheets is placed in a first ion-exchange bath with a first ion-exchange salt bath, usually a salt bath that has been used and is relatively poisoned when compared to the second salt bath, and then the same cassette holding the same glass sheets are placed in a second ion-exchange bath with a second ion-exchange salt concentration that is relatively fresh salt compared to the first salt bath. Compared with the SIOX process, the DIOX process allows a more poisoned bath to be used in as the first ion-exchange bath and has been shown to improve salt utilization, save time, and extend the use and lifetime of the salt bath without adding much complexity beyond SIOX process. For both SIOX and DIOX processes, the molten salt vessel with high concentration of effluent ions, such as Na⁺, is drained and then the vessel is refilled with fresh salt, which needs to be melted before processing next batch of glass sheets. This operation requires extended processing time, is costly and is very labor intensive and time consuming.

While the SIOX and DIOX batch processes have been found commercially useful, it is desirous to find a process at addresses the problems encountered with them, for example, finding a process that increases salt utilization before it has to be discarded, improves product strength consistency and improves compressive stress without adding much complexity beyond the SIOX process.

### SUMMARY

This disclosure is directed to a continuous flow ion-exchange process (CIOX) in which a fresh molten salt, for example a KNO₃, is supplied to one end of a long channeled containment vessel and the used molten salt is removed from the other end of the channel. A long channel containment vessel is described in commonly owned U.S. Patent Application Publication No. 2011/0293942.

In the CIOX process glass sheets are held in a cassette that is totally immersed in the molten salt and the cassette moves in a counter-current fashion relative to with the salt flow in the vessel. For example, as illustrated in FIG. 1, when the cassette movement is from left-to-right as shown by arrow 18, the salt flow is from right-to-left as shown by arrow 19. Fresh salt is continuously added at the right end of the vessel and used salt is continuously removed from the left end. This induces a continuous flow of the molten salt in the long ion-exchange vessel. In one embodiment of the CIOX process, cassettes holding the glass sheets are placed into the vessel at the salt outlet end, continuously moved through the vessel to the salt inlet end against the salt flow in a counter-current fashion, removed from the vessel at the salt inlet end. After removal from IOX bath the glass sheets are washed to remove any excess salt adhering to them and then sent for further processing. The CIOX process induces a concentration gradient with more poisoned salt at the salt outlet end and fresh salt at the salt inlet end due to continuous feeding of molten salt. In another embodiment the long CIOX vessel can have segmented chambers and the process works like a canal lock system, for the “Erie Canal” lock system. In a further embodiment the channel is serpentine and not straight.

The CIOX process is a continuous ion-exchange process with continuously fed fresh salt at the salt inlet end and poisoned salt removed at the salt outlet end with a counter-current molten salt flow and glass movement. The advantages of this continuous ion-exchange process over SIOX and DIOX are:
1. Improved salt utilization.
2. Increased production capacity per asset.
3. Improved product consistency.
4. Improved product attributes: increased CS due to a more poisoned bath through which a glass sheet passes in the beginning of its ion-exchange, and increased allowable CS with given frangibility limit towards GPa for a thin cover glass.

### BRIEF DESCRIPTION OF THE DRAWINGS

Referring to the drawings in general, it will be understood that the illustrations are for the purpose of describing particular embodiments and are not intended to limit this disclosure or the claims appended thereto. The drawings are not necessarily to scale, and certain features and certain views of the drawings may be shown exaggerated in scale or in schematic in the interest of clarity and conciseness. In addition, in order to clarify that is being disclosed and claimed, certain elements such as heaters to keep the salt in the vessel molten, pumps or other elements to move salt into or out-of the vessel, load/remove the cassettes containing the glass and other elements whose use would be known to those skilled in the art are not described.

FIG. 1 is an illustration of a long linear-channeled molten salt containment vessel showing the salt inlet 14 and outlet 16 ends, and the flow direction for the molten salt and the cassettes carrying the glass sheets.

FIG. 2 is an illustration of a molten salt containment vessel that has a one channel serpentine path for the flow of the molten salt and movement of the cassettes therein that are carrying the glass sheets undergoing ion-exchange.

FIG. 3 is a graph showing the KNO₃ wt. % profile in the bath and the accumulated K⁺ ion uptake by processed glass as a function of process length from a mass balance analysis, the process length being the length of the containment vessel.

FIG. 4 illustrates the relevant process parameters for the CIOX process.

FIG. 5 is an illustration of various flow design and operations that can be used to maintain a selected salt concentration, for example the use of a lock system between cassettes.

FIG. 6 illustrates the effect of glass sheet packing density in baths with the same dimensions.

FIG. 7 is a graph illustrating the effect of glass packing density on the glass processing rate.

FIG. 8 is a graph illustrating the effect of glass packing density on molten salt residence time.

FIG. 9A and FIG. 9B illustrates the effect of salt poisoning levels at the salt outlet end of a CIOX molten salt bath.

FIG. 10 is a graph of the wt. % NaNO₃ versus normalized channel length/time at the salt outlet end of the containment vessel for the CIOX process.

FIG. 11 is a graph of the K⁺ normalized concentration versus distance from the surface of the glass sheets; that is, the K+ concentration profile in the glass from the surface to a depth of approximately 70 μm for the SIOX and CIOX processes.

FIG. 12A is the stress profile for ion-exchanged glass made using the CIOX process in the first 100 μm from the glass surface into the glass compared to the SIOX process.

FIG. 12B is the stress profile for ion-exchanged glass made using the CIOX process in the first 2 μm of the glass surface into the glass compared to the SIOX process.

FIG. 13 is a graph illustrating the experimentally measured compressive stress versus wt. % NaNO₃ in first salt bath in a DIOX process.

FIG. 14 are the modeling result for compressive stress versus wt. % NaNO₃ for the DIOX process of FIG. 13.

FIG. 15 is an illustration indicating that the desired mixing plane is perpendicular to the direction of the process flow.

FIG. 16 illustrates the velocity and temperature profiles inside the containment vessel.

### DETAILED DESCRIPTION

Herein the glass undergoing ion-exchange is referred to as a “glass sheet,” or “glass sheets” as the case may be. These glass sheets are sized to fit the ion-exchange cassettes that will carry them and the cassettes are in turn sized to fit the molten salt containment vessel. Herein the term “cassette” means any carrying device or article containing one or more glass sheets that is used to immerse the glass sheets in a salt bath and transport the glass sheets along the length of the bath from salt outlet end to salt inlet end. Herein the term “vessel” is to be understood as meaning the “salt containment vessel.” Further, the vessel may have different shapes, for example, a rectangular or “U” shape, and the path within the vessel along which a cassette is “moved” or “translated” can be linear or serpentine. Herein, the terms “salt inlet end” and “inlet end,” and “salt outlet end” and “outlet end” may be used interchangeable, respectively.

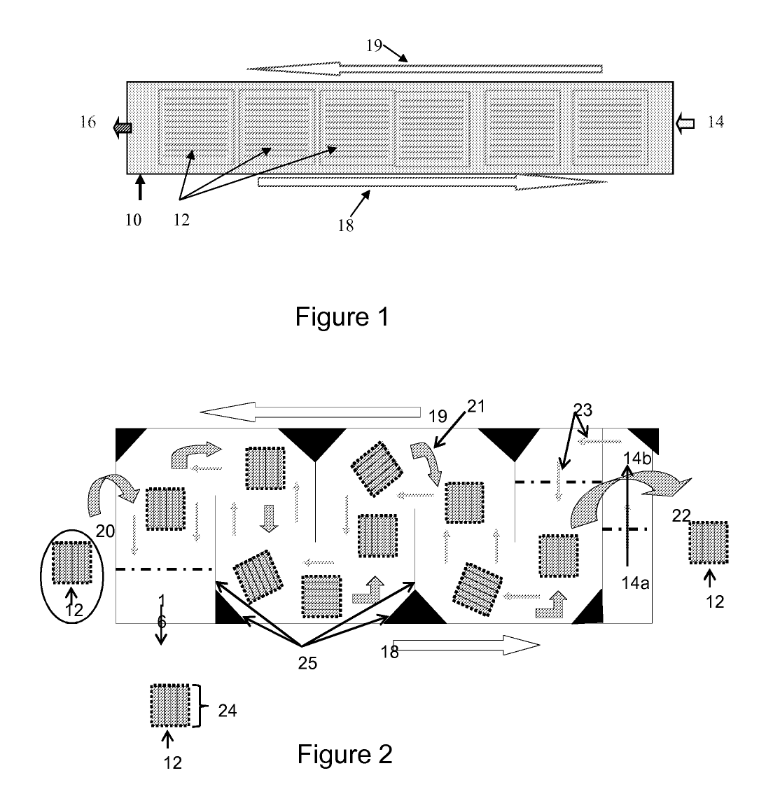

The present disclosure is directed to a continuous flow IOX (CIOX) process, for example as illustrated in FIG. 1, in which fresh molten salt, for example KNO₃ salt, is continuously supplied from one end of a long ion-exchange vessel 10, hereafter referred as the “salt inlet end” indicated by numeral 14, and the poisoned salt is continuously removed from the other end of the ion-exchange vessel hereafter referred as the “salt outlet end” indicated by numeral 16. This induces continuous flow of the molten salt in the long ion-exchange vessel 10 from the salt inlet end 14 to the salt outlet end 16 as indicated by arrow 19. At the same time, the cassettes 12 holding glass sheets are placed in the vessel at the salt outlet end 14; are continuously moved toward the salt inlet end 16 in a counter-current fashion, indicated by arrow 19, with the salt flow direction indicated by arrow 18; and subsequently the cassettes 12 are removed from the vessel 10 when they reach the salt inlet end 14, and the cassettes and glass sheets therein are washed to remove excess salt from the ion-exchange bath and then sent to other locations for further processing of the glass sheets. The salt flow direction will be in parallel with the glass surface lateral direction as shown in FIG. 1 or a tangent direction if the glass sheets in the glass in the cassettes has been tilted a few degrees, less than 10 degrees, off the vertical for better handling. In one embodiment the tilt is less than 5 degrees. The flow of the salt will induce a concentration gradient resulting in the more poisoned salt being at the salt outlet end 16 as glass sheets are moved in direction 18 and ion-exchanged and fresh salt is continuously added to the bath at the salt inlet end 14. In this disclosure's counter-current method the glass sheets are first ion-exchanged in a poisoned salt region at the salt outlet end 16, are gradually moved towards the salt inlet end 14 and ion-exchanged in less and less poisoned bath areas of the salt bath, and eventually are ion-exchanged in the fresh salt at the salt inlet end 14 before being removed from the salt bath. The final ion-exchange in fresh salt ensures that CS target or specification value will be obtained.

FIG. 1 illustrates a rectangular containment vessel in which the cassettes 12 are moved linearly through the vessel from salt outlet end 16 to salt inlet end 14. However, CIOX ion-exchange vessels can be designed so that different, non-linear paths are used to transport the cassettes through the on-exchange vessel. Various other vessel shapes or configurations could be employed in the CIOX process, for example, a U-shaped vessel. FIG. 2 illustrates a rectangular vessel in which both the molten salt and the cassettes move in a single channel along a serpentine path. The vessel illustrated in FIG. 2 has various “baffles” throughout the vessel to channel the salt flow along the serpentine path

A global mass balance was done for the CIOX system in order to determine the process parameters and preferred operating window(s). The CIOX concepts were developed and studied using the following parameters.
1. The vessels were 20 m, 50 m, 100 m, and 200 long in length, 1 m wide and 1.2 m in depth.
2. The packing density of glass was in the range of 1-20% of the salt vessel volume. Glass volume is the product of glass width, length and thickness and is dependent on the packing density.
3. The total glass area within a given cassette varied with the packing density. A glass sheet of size 1 m×1 m would have a total surface area of 1 m².
4. The glass residence time in the molten salt vessel was 5 hours.
5. Strengthened glass requires 0.19 mole “K ion”/m² of glass.
6. The waste salt exited the process at the outlet end 16 at either (a) 90 wt % KNO₃/10 wt % NaNO₃ or (b) 95 wt % KNO₃/5 wt % NaNO₃.

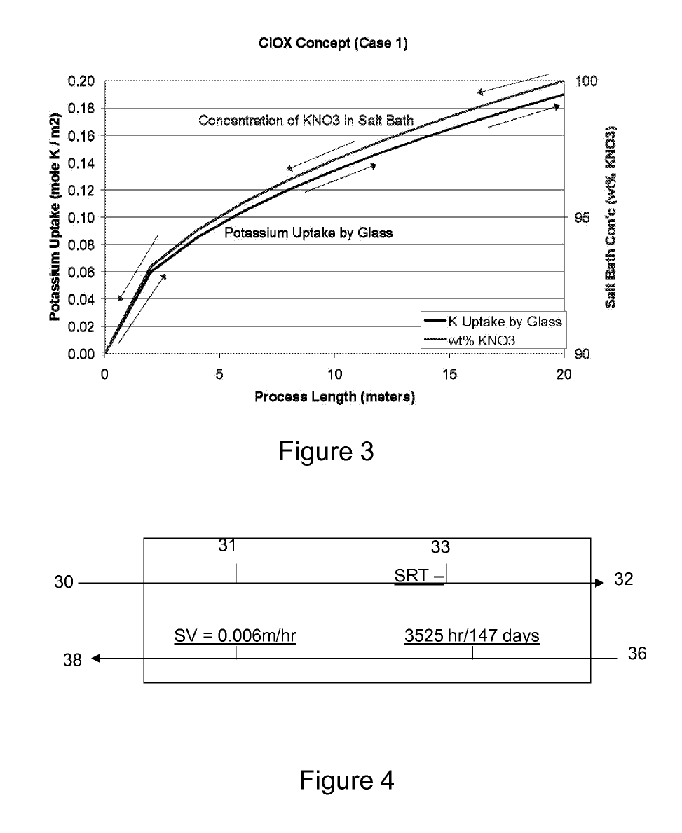

FIG. 3 is a graph illustrating the potassium uptake into the glass and the concentration of KNO₃ in the molten salt across the process length which can be the length of the vessel as illustrated in FIG. 1 or the length of a process path within a vessel as illustrated in FIG. 2. Ideal counter-current flow contacting between the phases was assumed; the vessel length was 20 m, and poisoned salt at the salt outlet, “process length 0,” was 90 wt % KNO₃/10 wt % NaNO₃. This foregoing profile will be kept the same for all different glass packing densities considered as other process parameters are adjusted at the same time. In FIG. 3 the upper curve is the KNO₃ profile in the bath and the lower curve is the accumulated K ion uptake by the glass from a mass balance. The individual glass sheets were 1 m wide, 1 m long and 0.55 mm thick. Counter-current flow was established and the ion-exchange was found to obey Fick's laws of diffusion. The arrows above the upper curve represent the salt flow direction illustrated by arrow 19 in FIG. 1, and the upper curve illustrates the depletion of the depletion of K ions in the salt bath as it approaches the salt outlay end. The arrows under the lower curve represent are the counter-current direction 18 of the cassettes and glass sheets illustrated in FIG. 1.

FIG. 4 is a diagram showing the flow rates and nominal residence times and velocities of the glass and molten salt of the baseline concept described above. Cassettes containing sheets of glass enter the process on the left side of FIG. 4 at numeral 30 and move across the length of the process at a velocity 31 of 4 m/hour, having a nominal residence time 33 in the bath of 5 hours until they reach the right side at numeral 32 where the glass, now chemically strengthened by ion-exchanged, is removed. The vessel in FIG. 4 has dimensions, L×W×D, 0f 20 m×1 m×1.2; the volume thus being 24 m³. The ratio of glass volume in the vessel to the vessel volume, the packing density, is 0.01 or 1% of the vessel volume.

Further referring to FIG. 4, fresh salt at 100 wt % KNO₃ enters the process at a rate of 12 kg/hr. at numeral 36 on the right. The molten salt flows counter-current to the glass motion at a salt velocity, SV, of 0.006 m/hour in the direction 36→38 and exits as waste or poisoned salt on the left at numeral 38. This leads to a long salt residence time, SRT, of 3525 hours or 147 days. The waste salt is nominally 90 wt % KNO₃/10 wt % NaNO₃. During the process, the salt bath loses K ions to the glass which takes up 0.19 mole of K ions per meter square glass sheet, and smaller alkali ions in the glass exchange into the molten salt.

The packing density of glass within the process is inversely related to the mean residence time of the molten salt. The velocity and mean residence time of the molten salt are important for at least two reasons:
1) The mean residence time of the salt determines the responsiveness of the process to changes. The time required to start-up the process or implement a process change will be some multiple of the mean residence time. Initial calculations on the baseline glass packing density (1%) show 147 day mean residence time. It is desirable to shorten this considerably. The most direct way is the increase the packing density of the glass in the cassettes.
2) The velocity of the salt will affect the flow patterns within the vessel that develop as the salt in the vessel moves counter-current to the glass. The baseline concept has glass moving at 4 m/hr., and salt moving only at 0.006 m/hr. In this case the motion of the glass will drive the flow of molten salt. It is desirable to increase the salt velocity over this base value and increasing the packing density is the most direct way to achieve this.

The calculations shown in FIGS. 3 and 4 assume an ideal counter-current flow situation. However, in practice the actual profile may deviate from the ideal due to salt flow by-passing around the cassettes of glass, thermal convection, and back-mixing. To promote ideal counter-current flow baffles 25 can be added to prevent flow by-passing such as are shown in FIG. 2, active locks and sluices can be used, and enhanced transverse mixing can be done using bubbles and thermal convection. In FIG. 2 the salt outlet end is 16; the salt inlet end is 14a,14b, where 14a is salt loading and 14b is salt melting; the loading of cassettes 12 contain the glass sheets into the vessel is 20 and the unloading of cassettes 12 containing the ion-exchanged glass sheets is at 22; and the cassette itself can have baffles such as those numbered 24 in the enlargement of cassette 12. Also in FIG. 2 broad arrows 21, whether curved or straight, represent movement of the cassette 12 through the vessel and the narrow arrows 23 represent the flow of the molted salt through the vessel.

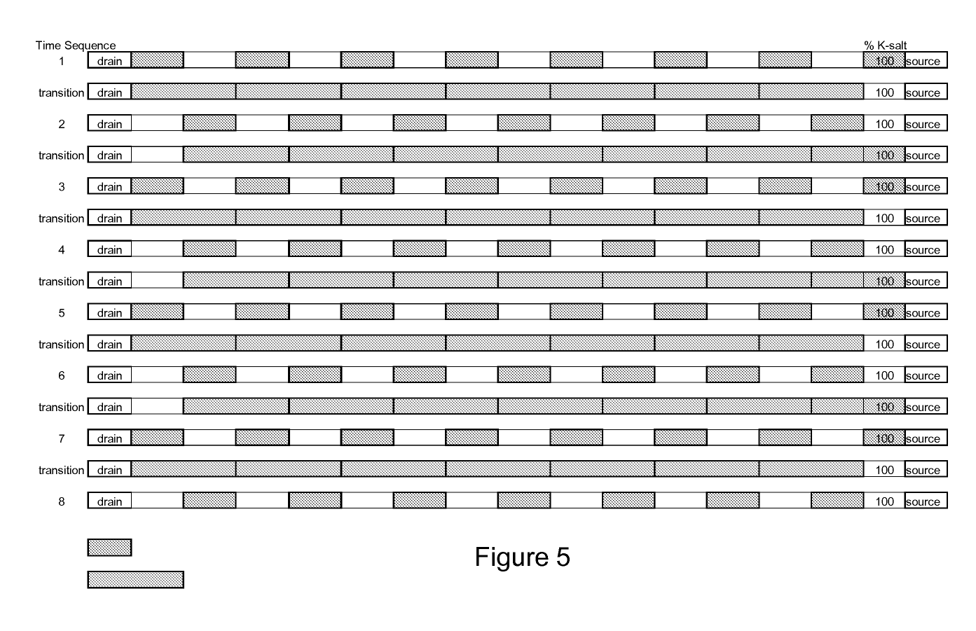

FIG. 5 illustrates a CIOX design with an active lock system. The long CIOX vessel in this design has segmented chambers and the process works like “Erie Canal” lock system. Locks separate two chambers of a CIOX vessel so that salt from one chamber does not flow to the adjacent chambers when locks are on. In FIG. 5 cassette movements is from left to right and salt flow is from right to left. The process works as following,
1) A cassette holding numerous glass sheets stays in one chamber for a specified period of time for ion-exchange with the lock on;
2) The lock between the current chamber and a next chamber in the direction the cassette is moving is opened;
3) Salt between these two chambers will be mixed and cassette moves from the current chamber to the next chamber in the direction of motion;
4) The lock is between the two chambers is closed; and
5) The process continues and is repeated until the cassette reaches the last chamber where it is removed after completing its residence in the last chamber.

In all these CIOX designs, cassettes holding glass sheets are preferred to have high glass packing density. In one embodiment the glass volume to process volume is in the range of 10%-20% v/v with a means to transport across the length of the CIOX vessel/bath/channel.

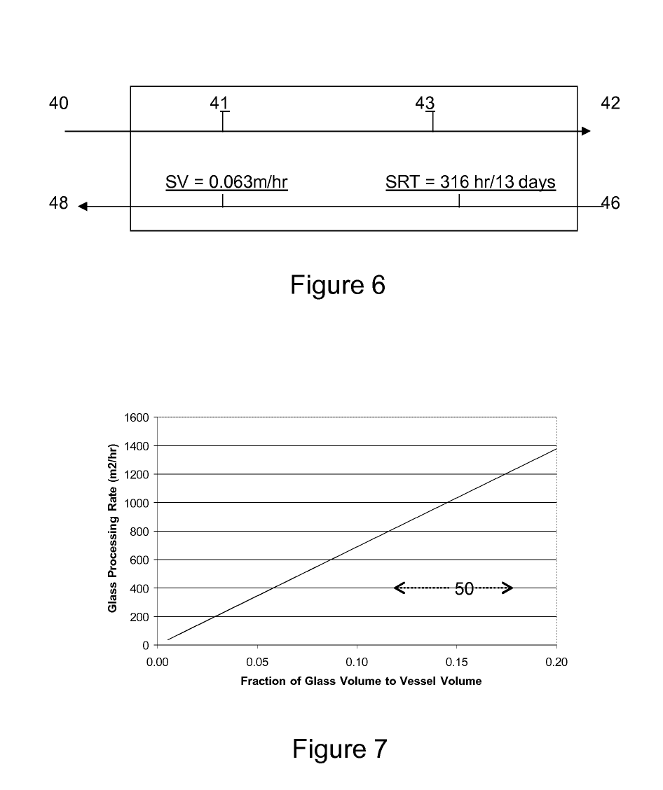

FIG. 6 compares process parameters for 10% glass packing density in the cassettes vs. 1% packing density as in FIG. 4. The glass throughput increases from 70 m²/hr. to 700 m²/hr. illustrating that this is an important process knob to increase production. In addition, the 10% packing density reduces salt residence time SRT by more a factor of 10, from 147 or 13 days. Residence time is important because it affects the time response of the process to start-up or set-up changes.

FIG. 6 is a diagram showing the flow rates and nominal residence times and velocities of the glass and molten salt when the cassettes have a glass packing density of 10%. Cassettes containing sheets of glass enter the process on the left side of FIG. 6 at 40 and move across the length of the process at a velocity 41 of 4 m/hour, having a nominal residence time 43 in the bath of 5 hours until they reach the right side at 42 where the glass, now chemically strengthened by ion-exchanged, is removed. The vessel in FIG. 6 has dimensions, L×W×D, of 20 m×1 m×1.2 m, the volume thus being 24 m³. The ratio of glass volume in the vessel to the vessel volume, the packing density, is thus 0.10 or 10% of the vessel volume.

Further referring to FIG. 6, fresh salt at 100 wt % KNO₃ enters the process at a rate of 115 kg/hr. at 46 on the right. The molten salt flows counter-current to the glass motion at a salt velocity SV of 0.063 m/hour in the direction 46→48 and exits as waste or poisoned salt on the left at 48. This leads to a salt residence time SRT of approximately 13 days. The waste salt is nominally 90 wt % KNO₃/10 wt % NaNO₃. During the process, the salt bath loses K ions to the glass which takes up 0.19 mole of K ions per meter square glass sheet, and smaller alkali ions in the glass exchange into the molten salt. Note that the velocity and residence time of the glass is the same in FIGS. 4 and 6. As a result of the increased salt flow rate and packing density of the glass in the cassettes higher throughput per hour is achieved

FIG. 7 is a graph of Glass Processing Time vs. Glass Packing Density illustrating how packing density affects glass throughput. The vessel size is 20 m×1 m×1.2 m and the glass has a thickness of 0.7 mm. The glass process rate or throughput increases linearly with the glass packing density. A glass packing density 10-20% as illustrated by the dashed double arrow 50 is preferred for high throughput and better salt utilization. The waste salt is 90 wt % KNO₃/10 wt % NaNO₃.

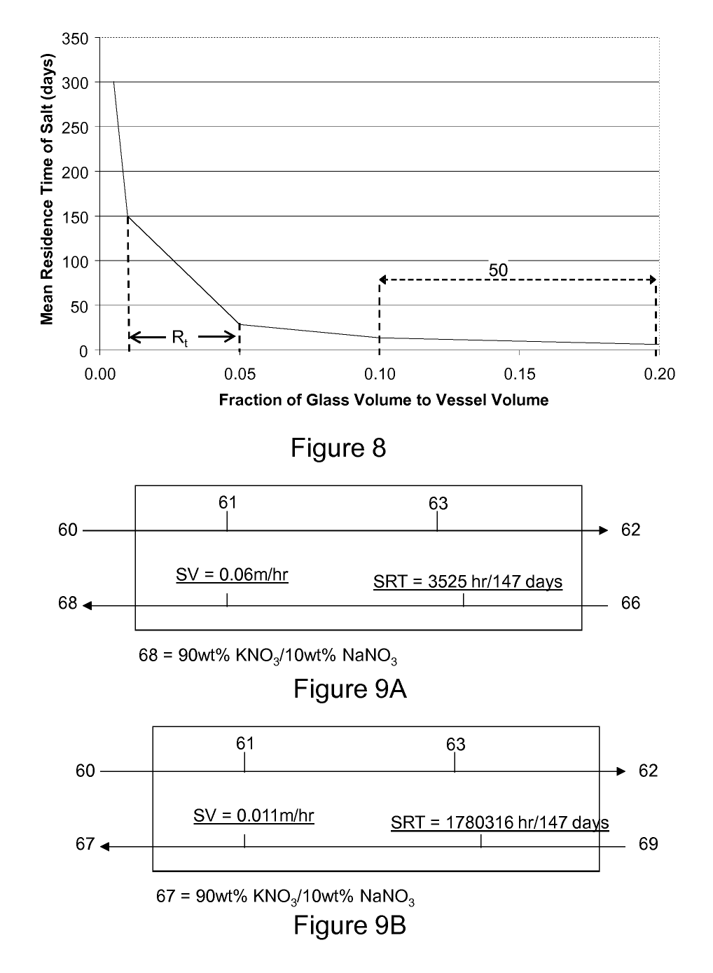

FIG. 8 is a graph of Molten Salt Residence Time vs. Glass Packing Density illustrating how packing density affects the mean residence time Rₜ of the molten salt. The mean residence time Rₜ drops quickly from 1% to 5% as illustrated by the. Glass packing densities in the 10-20% range are preferred as illustrated by the dashed double arrow 50. The waste salt is 90 wt % KNO₃/10 wt % NaNO₃.

FIGS. 9A and 9B show the effect of salt poisoning level on process flows and residence times. Changing the KNO₃ concentration in the waste or poisoned salt from 90 wt. % to 95 wt. % at the salt outlet end increases the average salt velocity SV, reducing the salt residence time SRT by one-half. However, more salt is used per processed area of glass. A more poisoned salt would be preferred for salt utilization, but a less poisoned bath would be preferred if process response time is more important. In FIGS. 9A and 9B the vessel volume is 24 m³, the glass volume is 0.245 m³ for a 1% packing density, the velocity 61 of the cassettes containing the glass is 4 m/hr. and the residence time 63 of the glass in the bath is 5 hours. The cassette are loaded at 60 and removed at 62. In FIG. 9A the waste salt 68 is 90 wt % KNO₃/10 wt % NaNO₃. In FIG. 9B the waste salt 67 is 95 wt % KNO₃/5 wt % NaNO₃. In order to process the same amount of glass to the same specification values for compressive stress and depth of layer, the process of FIG. 9B requires twice the salt, 23 kg/hr., used in the FIG. 9A process which is 12 kg/hr.

Table 1 shows the effects of process path length for vessels having lengths of 20, 50, 100 and 200 meters, the width and height of the vessels remaining the same at 1 m and 1.2 m, respectively. Increasing the process length proportionally increases glass throughput, increases salt flow rate, and increases the average velocity of the salt. However, given that the same glass residence time, 5 hours, for the glass, the salt residence time remains constant at 147 days.

TABLE 1

| | Vessel Length “L” × W = 1 m × H = 1, 2 m | | | |
|---|---|---|---|---|
| | L = 20 m | L = 50 m | L = 100 m | L = 200 |
| Vessel Volume, m³ | 24 | 60 | 120 | 240 |
| Glass Volume, m³ | 0.245 | o.6125 | 1.225 | 2.45 |
| Ratio: Glass Volume/Vessel | 0.01 | 0.01 | 0.01 | 0.01 |
| Volume | | | | |
| Glass throughput, m²/hour | 70 | 175 | 350 | 700 |
| Glass velocity, m/hour | 4 | 10 | 20 | 40 |
| Glass residence time, | 5 | 5 | 5 | 5 |
| hours | | | | |
| Salt residence time SRT, | 147 | 147 | 147 | 147 |
| days | | | | |
| Salt velocity, SV m/hour | 0.006 | 0.014 | 0.028 | 0.057 |
| Fresh salt feed rate, | 12 | 29 | 58 | 115 |
| kg/hour | | | | |
| Waste salt KNO₃ content | 90 | 90 | 90 | 90 |

Fresh salt is 100 wt. % KNO₃

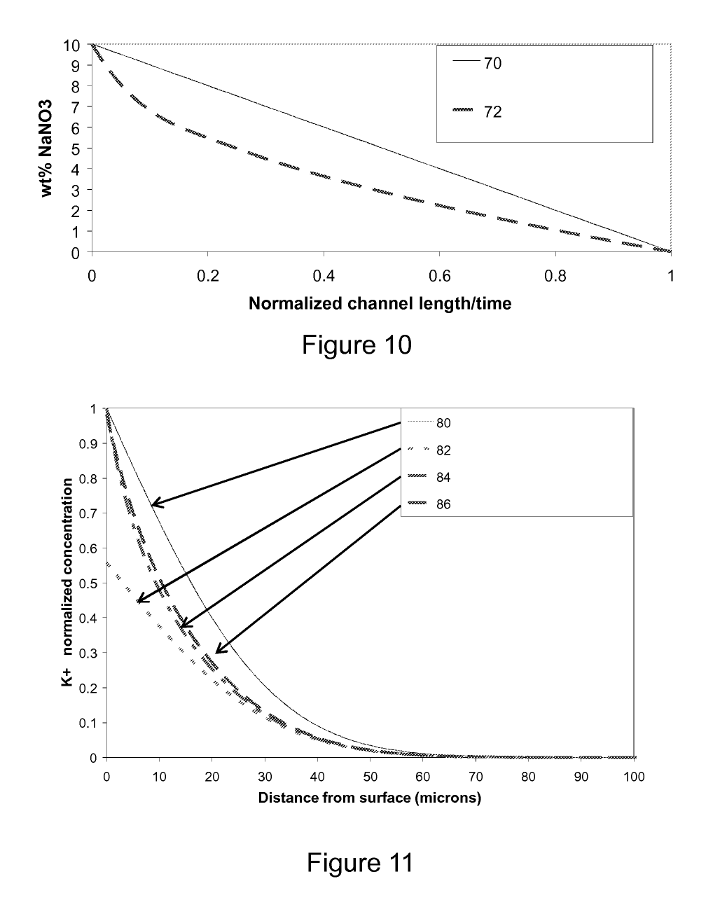

The CIOX processes bring also unique attributes to ion-exchanged glasses. A first-principle physics-based model with extension to take into account the time varying salt condition was developed to calculate exchanged ion concentration and stress profiles for CIOX. A few concentration gradient profiles along a CIOX vessel were considered in the calculation (FIG. 10). For example, the CIOX poisoning profile, by NaNO₃, from analysis (dashed curve 72) shown in FIG. 3 is the correspondent NaNO₃ wt. % concentration profile from the mass balance analysis with 90 wt % KNO₃ shown in FIG. 4 and discussed above. The CIOX NaNO₃ poisoning linear profile (solid line 70) is for reference and juxtaposition purpose. To compare with a single ion-exchange (SIOX) process, we also calculated the concentration profiles for SIOX with fresh salt and with 10 wt % NaNO₃ poisoning.

The exchanged ion concentration (KNO₃) profiles for both SIOX and CIOX are plotted in FIG. 11. The surface concentration of KNO₃ is normalized as “1” for fresh salt. The graph shows that exchanged ion concentration decays faster from the surface than SIOX with fresh salt. The reduction is proportional to the maximum poisoning level of the salt at the CIOX salt outlet end. This leads to smaller amount of exchanged ion (K⁺) into the glass sample compared with SIOX, hence the smaller thickness-averaged K⁺ concentration. Numeral 80 is SIOX using fresh salt; 82 is SIOX at 10 wt. % NaNO₃ poisoning; 84 is CIOX 10 wt % NaNO₃ linear profile; and 86 is CIOX 10 wt % NaNO₃ profile from analysis,

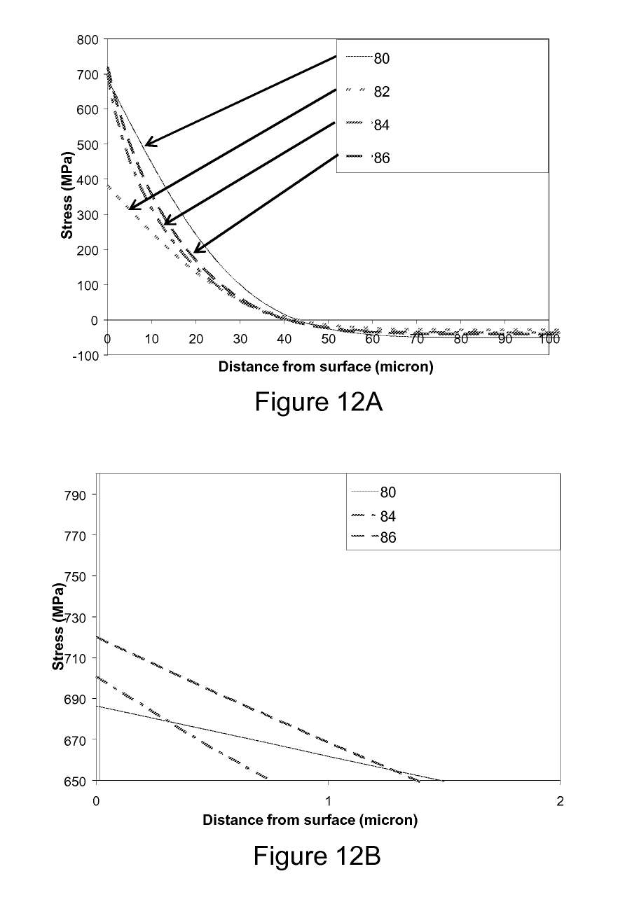

The corresponding stress profiles to those concentration profiles of FIG. 11 are plotted in FIGS. 12A and 12B. In FIG. 12 A the stress profiles are for first 100 μm of the glass surface and in FIG. 12B the stress profiles are for the first 2 μm of the glass surface. Similar to concentration behavior, the stress profiles are steeper for CIOX while meeting CS and DOL targets. The smaller thickness-averaged K⁺ concentration leads to reduced center tension. This will be important when frangibility becomes a concern for very high CS thin glass sheets. Also CS values increase in CIOX compared with SIOX. The numerals in FIGS. 12A and 12B have the same meaning as in FIG. 11. Curve 82 does not appear in FIG. 12B which covers only the first 2 μm of the glass surface (see FIG. 12A).

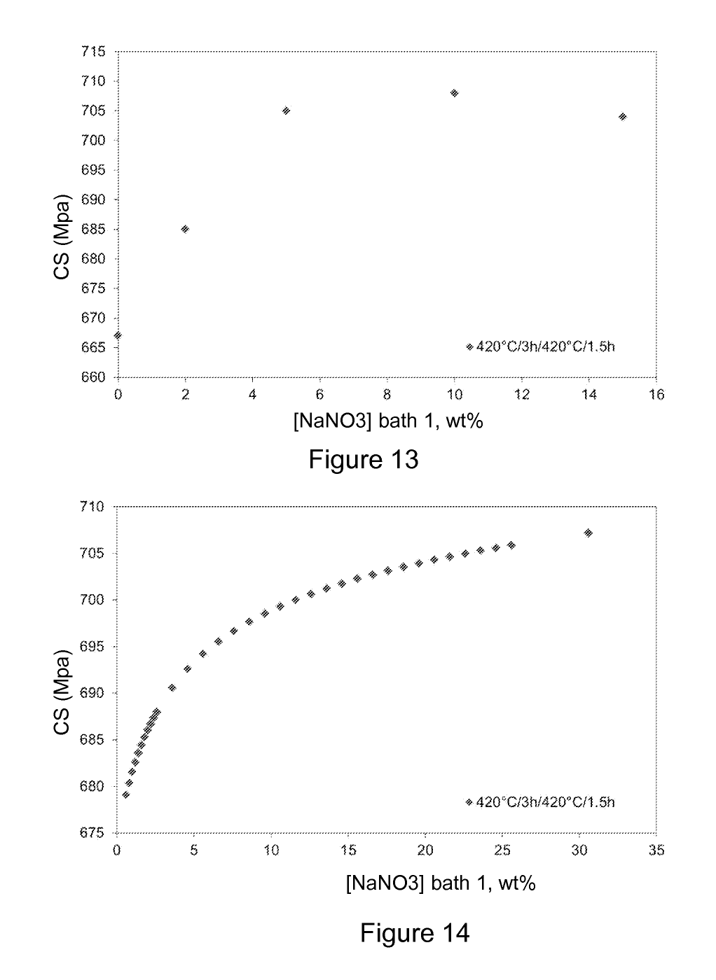

The basic physical principles at work are the following which, though originally developed for a DIOX process, were found to be applicable to the CIOX process. The compressive stress at the surface is approximately given by the equation

$$\vert CS \vert = \frac{BE}{1 - v} ( {C}_{surf} - {C}_{avg} ( t ) ) \qquad ( 1 )$$

where |CS| is the magnitude of surface compressive stress, B is the lattice dilation coefficient, E is Young's modulus for the glass, ν is the Poisson ratio, C_{surf} is the surface concentration of K₂O ions, and C_{avg}(t) is the time-dependent average concentration. The average concentration is physically present to satisfy the condition of force balance whereby the integral of stress through the thickness is zero. As is evident from Eq. (1), force balance reduces |CS|, that is, the physically required center tension that balances the surface compression also reduces its magnitude. Center tension is given by the related equation

$$CT = \frac{BE}{1 - v} ( {C}_{avg} ( t ) - {C}_{base} ) \qquad ( 2 )$$

where C_{base} is the base glass concentration of K₂O. This shows that center tension CT grows as C_{avg} grows. C_{avg} is the average concentration of K₂O throughout the glass. When an initial phase of ion-exchange is performed in a relatively poisoned salt bath, fewer K ions enter the glass and C_{avg} is a smaller number. This reduces CT, which has two benefits: (1) The reduced C_{avg} and CT values allow a larger CS, and (2) reduced CT keeps the stress in the part further below the frangibility limit. When CT grows too large there is too much elastic energy stored in the part and on breakage it flies apart with too much kinetic energy for certain applications. Thus ion-exchange that starts in a relatively poisoned bath allows a higher CS for a given frangibility limit. If the entire ion-exchange were performed in a poisoned salt bath then the reduction of C_{surf} would, as seen in Eq. (1), reduce the magnitude of CS. This is shown in FIGS. 12B and 12B for the poisoned SIOX case. However when an ion-exchange is performed starting in a relatively poisoned salt bath and finishing with a relatively pure salt bath, CS is higher due to smaller CT combined with good C_{surf} near the end of the ion-exchange. The detailed stress profile resulting from a given choice of salt quality throughout the ion-exchange can be calculated by incorporating the changing boundary condition C_{surf} throughout the ion-exchange. FIGS. 12A and 12B show such a model calculation result. The reduction in CT is seen where the stress curves cross into positive values. Among the profiles with favorable CS, Profile 1 (linear poisoning) has the lowest C_{avg} and the lowest CT, hence the highest magnitude of CS. FIG. 13 shows experimental evidence for this effect in a DIOX process.

FIG. 14 shows a model result for the same DIOX case of FIG. 13. This shows the same overall shape. The model result uses Eq. (1) for the appropriate conditions of the DIOX process under study.

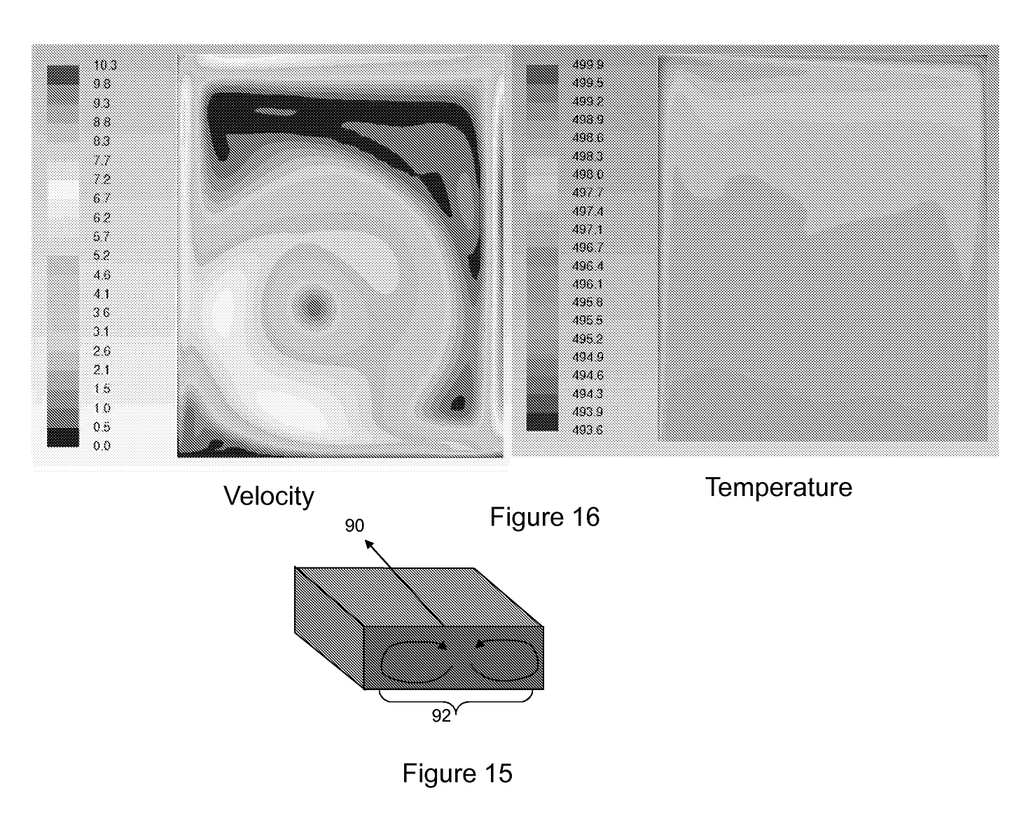

As mentioned above in the mass balance analysis, maintaining a counter-current flow is critical to the process. Thermal convection can be manipulated to promote this and is illustrated in FIG. 15 is a schematic view of the desired mixing direction inside a channel. The molten salt flow directing is represented by the arrow 90 and numeral 92 illustrates the mixing plane. In this configuration, the temperature variation at a certain position is minimized while the deliberately imposed variations along the flow direction can be sustained. Since the density of the KNO₃ salt is strongly dependent on the temperature, natural convection can be utilized by strategically placing the heating elements in the design. The desired configuration would be placing the heaters on the vertical side walls. In this configuration mixing due to natural convection would be promoted. A further improvement on the mixing characteristics can be achieved if the ambient gas environment is kept at a slightly lower temperature than the targeted salt bath temperature. The heater thus provide agitation of the molten salt to aid in provide uniformity as it travels from the inlet end to the outlet end. Agitation can also be provided by the use of baffles.

While keeping the ambient conditions at a lower temperature sounds counterintuitive in attaining a uniform temperature distribution throughout the salt, the recommended configuration is simulated using models. The configuration was analyzed through computational fluid dynamics and a sample result is shown in FIG. 16. In the analysis, the surface temperature of the heaters was set to approximately 500° C. The velocity distribution shows a large circulation zone that alleviates the variability in temperatures. The local flow velocity can reach as high as a few millimeters per second and at this level mixing results in a very uniform temperature profile within the vessel as indicated by the temperature distribution. The peak variation in temperature is around 6° C., while the region that the glass sheets are exposed to show about 1° C. variability despite the 50° C. temperature difference between the heater set temperature and the ambient furnace temperature. Illustrated in FIG. 16 is a velocity flow of 5 mm/second and a total temperature variation of approximately 5° C.

What is described in this disclosure is a continuous ion-exchange system, the system comprising an ion-exchange vessel, the ion-exchange vessel having an inlet end, the inlet end comprising a molten salt source, and an outlet end distal to the inlet end, the outlet end comprising a molten salt drain; a molten salt, the molten salt comprising a first salt having a first concentration and a second salt having a second concentration, wherein the first concentration and second concentration vary form the inlet end to the outlet end; a cassette disposable in the ion-exchange vessel, where in the cassette is capable of holding at least one glass article to be ion-exchanged; and a translation element for translating the cassette from the outlet end to the inlet end of the ion-exchange vessel. An exemplary translation element is an overhead rail system capable of raising and lowering the cassettes into and out of the molten salt bath, and of moving the cassettes through salt bath from one end of the vessel to the other. The system can further comprise an agitation element to establish a flow of the molten salt counter-current to a direction in which the cassette is translated, and the agitation element establishes the flow from the inlet end to the outlet end. In particular, the agitation element establishes a continuous concentration gradient in the molten salt. The agitation element comprises at least one baffle and/or at least one heater. The molten salt flow through the vessel is at least 0.006 m/hr. A molten salt source provides only the first salt to the ion-exchange vessel, and the concentration of the first salt at the inlet end is approximately 100%. The concentration of the first salt at the outlet end is less than or equal to approximately 95%. In an embodiment the concentration of the first salt at the outlet end is less than or equal to about 90%. The first salt is a potassium salt and the second salt is a sodium salt. In an embodiment the potassium salt is KNO₃ and the sodium salt is NaNO₃. In one embodiment the ion-exchange vessel comprises a linear channel joining the inlet end and the outlet end through which the cassette is translated from the vessel outlet end to the vessel inlet end. In another embodiment the ion-exchange vessel comprises a serpentine channel through which the cassette is translated from the vessel outlet end to the vessel inlet end. In a further embodiment the ion-exchange vessel comprises a U-shaped channel joining the inlet end and the outlet end through which the cassette is translated from the vessel outlet end to the vessel inlet end. In a further embodiment the ion-exchange vessel comprises a plurality of segmented chambers through which the cassette is translated from the vessel outlet end to the vessel inlet end. When the segmented chambers are present, the segmented chambers are separated by locks, wherein the locks are movable to allow fluid communication between adjacent segmented chambers and movement of the cassette between the adjacent segmented chambers. The ion-exchange vessel has a length of at least 20 meters. The cassette further comprises a baffle to prevent flow of the molten salt from bypassing the cassette. The cassette is adapted to hold the glass article such that a surface of the glass article is parallel to a direction of translation of the cassette from the inlet end to the outlet end. The cassette may also be adapted to hold at least one glass article, the glass article having a surface area and a volume, and wherein the volume of the glass article comprises from 1% to about 20% (10-20) of a volume of the molten salt. The cassette is adapted hold the at least one glass article wherein the surface area of the at least one glass article is approximately 1 m². In one embodiment the surface area of the glass article is at least 2 m²

What is also described in this disclosure is a method of ion exchanging at least one glass article, the method comprising disposing the at least one glass article in a cassette; disposing the cassette in an outlet end of an ion-exchange vessel containing molten salt, the ion-exchange vessel comprising the outlet end and an inlet end distal from the outlet end and the molten salt comprising a first salt having a first concentration and a second salt having a second concentration, wherein the first concentration and second concentration vary form the inlet end to the outlet end; and translating the at least one glass article from the outlet end to the inlet end, wherein the at least one glass article is ion-exchanged to a depth of layer while being disposed in the ion-exchange vessel.

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

We claim:

1. A continuous ion-exchange system, the system comprising:
an ion-exchange vessel, the ion-exchange vessel having an inlet end, the inlet end comprising a molten salt source, and an outlet end distal to the inlet end, the outlet end comprising a molten salt drain;
a molten salt, the molten salt comprising a first salt having a first concentration and a second salt having a second concentration, wherein the first salt concentration and second salt concentration vary from the inlet end to the outlet end;
a cassette disposable in the ion-exchange vessel, where in the cassette is capable of holding at least one glass article to be ion-exchanged;
a translation element for translating the cassette from the outlet end to the inlet end of the ion-exchange vessel, and
an agitation element to establish a flow of the molten salt counter-current to a direction in which the cassette is translated, the molten salt having a continuous concentration gradient from the salt inlet end to the salt outlet end of the vessel;
wherein the cassette is adapted to hold the at least glass article such that a surface of the glass article is parallel to a direction of translation of the cassette from the inlet end to the outlet end.

2. The system of claim 1, wherein the molten salt flow rate from inlet end to outlet end is at least 0.006 m/hr.

3. The system of claim 1, wherein the agitation element comprises at least one selected from the group consisting of baffles and heaters.

4. The system of claim 1, wherein the molten salt source provides only the first salt to the ion-exchange vessel, the concentration of the first salt being substantially 100%.

5. The system of claim 1, wherein the concentration of the first salt at the outlet end is less than or equal to about 95%.

6. The system of claim 1, wherein the concentration of the first salt at the outlet end is less than or equal to about 90%.

7. The system of claim 1, wherein the first salt is a potassium salt and the second salt is a sodium salt.

8. The system of claim 1, wherein the potassium salt is KNO₃ and the sodium salt is NaNO₃.

9. The system of claim 1, wherein the ion-exchange vessel is selected from the group consisting of:
a linear channel joining the inlet end and the outlet end through which the cassette is translated from the vessel salt outlet end to the vessel salt inlet end;
serpentine channel through which the cassette is translated from the vessel salt outlet end to the vessel salt inlet end;
a plurality of segmented chambers through which the cassette is translated from the vessel salt outlet end to the vessel salt inlet end; and
a U-shaped channel through which the cassette is translated from the outlet end to the inlet end.

10. The system of claim 9, wherein the segmented chambers are separated by locks, wherein the locks are movable to allow fluid communication between adjacent segmented chambers and movement of the cassette between the adjacent segmented chambers.

11. The system of claim 1, wherein the ion-exchange vessel has a length of at least 20 meters.

12. The system of claim 1, wherein the cassette further comprises a baffle to prevent flow of the molten salt from by-passing the cassette.

13. The system of claim 1, wherein the glass article has a surface area and a volume, and wherein the volume of the glass articles in the vessel comprises from 1% to 20% of the volume of the molten salt in the vessel.

14. The system of claim 1, wherein the cassette is adapted hold the at least one glass article wherein the surface area of the at least one glass article is approximately 1 m².

15. A method of ion exchanging at least one glass article, the method comprising:
providing a glass article containing metal ions that are exchangeable with larger metal ions,
disposing the at least one glass article in a cassette;
providing a vessel containing molten salt having an ion exchangeable with at least one ion in the glass article, the vessel having an outlet end for removing molten salt from the vessel and an inlet end for supplying a fresh molten salt to the vessel, the inlet end being distal to the outlet end;
providing an element for placing the cassette contain the at least one glass article into the molten salt bath at the vessels outlet end and translating the cassette from the vessel's salt outlet end to the vessel's salt inlet end to thereby ion-exchange metal ions in the glass with larger metal ions in the molten salt bath;
wherein:
the molten salt comprises a first salt having a first concentration and a second salt having a second concentration, wherein the first concentration and second concentration vary form the inlet end to the outlet end, and the concentration of the first salt at the vessel inlet end is substantially 100%; and
the first salt metal ions are larger than the second salt metal ions are ion-exchanged into the glass to relace the second salt metal ions; and
the at least one glass article is ion-exchanged to a selected depth of layer while being disposed in the ion-exchange vessel.
